(19) United States
(12) Patent Application Publication
(10) Pub. No.: US 2023/0037498 A1
(43) Pub. Date: Feb. 9, 2023

(54) METHOD AND SYSTEM FOR GENERATING A PREDICTIVE MODEL

(71) Applicant: HUAWEI TECHNOLOGIES CO., LTD., Shenzhen (CN)

(72) Inventors: Vladimir Mikhailovich KRYZHANOVSKIY, Moscow (RU); Nikolay Mikhailovich KOZYRSKIY, Moscow (RU); Stanislav Yuryevich KAMENEV, Moscow (RU); Alexander Alexandrovich ZURUEV, Moscow (RU)

(21) Appl. No.: 17/969,358

(22) Filed: Oct. 19, 2022

Related U.S. Application Data
(63) Continuation of application No. PCT/EP2020/061214, filed on Apr. 22, 2020.

(51) Int. Cl. G06K 9/62

(52) U.S. Cl. CPC G06K 9/6262; G06K 9/6227; G06K 9/6232; G06K 9/6253

(57) ABSTRACT

A method for generating a predictive model for quantization parameters of a neural network is described. The method comprises accessing a first vector of data values corresponding to input values to a first layer implemented in a neural network, generating a feature vector of one or more features extracted from the data values of the first vector, accessing a second vector of data values corresponding to the input values of a second layer implemented in the neural network, subsequent to the first layer, generating a target vector of data values comprising one or more quantization parameters for the second layer, from the data values of the second vector, evaluating, on the basis of the feature vector and the target vector, a predictive model for predicting the one or more quantization parameters of the second layer and modifying the predictive model on the basis of the evaluation.

### CROSS-REFERENCE TO RELATED APPLICATIONS

This application is a continuation of International Application No. PCT/EP2020/061214, filed on Apr. 22, 2020. The disclosure of which is hereby incorporated by reference in its entirety.

### TECHNICAL FIELD

The present disclosure relates to a system and method for generating a predictive model. In particular, the system and method described herein generate a predictive model for estimating quantization parameters of layers of a neural network.

### BACKGROUND

In recent years, machine learning algorithms have been deployed in a wide variety of contexts to perform tasks such as pattern recognition and classification. Machine learning techniques, such as deep learning, use artificial neural networks that mimic the behaviour of neurons in biological neural networks. An artificial neural network is run or ‘trained’ on samples from a training dataset comprising known input-output pairs. When a new, previously unseen input is introduced to the network, the trained network generates an output.

In many devices, such as user devices at the edge of a network, computational resources such as memory and power are limited. Computationally expensive techniques employing neural networks are therefore optimized to reduce the computational load on the device. For example, quantization is one technique that may be used to reduce computational loads. Quantization methods map data values in neural networks to values with lower bit-widths. This can be done by dynamically selecting parameters to quantize each layer of the network or statically selecting parameters before evaluation. Dynamic quantization is computationally more expensive than static quantization but ensures greater output accuracy when the neural network is evaluated.

### SUMMARY

It is an object of the invention to provide a method for for generating a predictive model for quantization parameters of a layer of a neural network.

The foregoing and other objects are achieved by the features of the independent claims. Further implementation forms are apparent from the dependent claims, the description and the figures.

According to a first aspect, a method for generating a predictive model for quantization parameters of a neural network is provided. The method comprises accessing a first vector of data values corresponding to input values to a first layer of a neural network, generating a feature vector of one or more features extracted from the data values of the first vector, accessing a second vector of data values corresponding to the input values of a second layer implemented in the neural network, subsequent to the first layer, generating a target vector of data values comprising one or more quantization parameters for the second layer, from the data values of the second vector, evaluating, on the basis of the feature vector and the target vector, a predictive model for predicting the one or more quantization parameters of the second layer and modifying the predictive model on the basis of the evaluation. The first and second vectors are generated on the basis of the evaluation of the neural network that is given by a sample from a training dataset for the neural network.

The method according to the first aspect generates a model for off-line quantization parameter estimation for a neural network. Quantization parameters generated according to this method improve the stability of the output of the quantized neural network.

According to a second aspect a system is provided. The system comprises at least one processor and at least one memory including program code. The program code, when executed by the at least one processor provides instructions to access a first vector of data values corresponding to input values to a first layer implemented in a neural network, generate a feature vector of one or more features extracted from the data values of the first vector, access a second vector of data values corresponding to the input values of a second layer implemented in the neural network, subsequent to the first layer, generate a target vector of data values comprising one or more quantization parameters for the second layer, from the data values of the second vector, evaluate, on the basis of the feature vector and the target vector, a predictive model for predicting the one or more quantization parameters of the second layer and modify the predictive model on the basis of the evaluation. The first and second vectors are generated on the basis of the evaluation of the neural network that is given by a sample from a training dataset for the neural network.

In a first implementation form the method comprises receiving a vector of data values corresponding to input values for the first layer of the neural network, generating a feature vector of one or more features extracted from the data values of the vector, evaluating the predictive model on the basis of the feature vector and generating one or more quantization parameters for the second layer, on the basis of the evaluation.

In a second implementation form the first layer and second layer are selected from layers of the neural network on the basis of a user-generated input.

In a third implementation form at least one of the features extracted from the data values of the first vector comprises a statistical function computed from the data values of the first vector.

In a fourth implementation form the predictive model is a linear predictive function, a non-linear predictive function, a neural network, a gradient boosting machine, a random forest, a support vector machine, a nearest neighbour model, a Gaussian process, a Bayesian regression and/or an ensemble.

In a fifth implementation form evaluating the predictive model comprises computing an output of the predictive model on the basis of the feature vector, and determining an error between the output and the target vector.

In a sixth implementation form modifying the predictive model on the basis of the evaluation, comprises modifying one or more parameters of the predictive model to minimise the error between the output and the target vector.

In a seventh implementation form the quantization parameters comprise parameters of a function that maps floating point numbers to fixed point numbers.

In an eighth implementation a predictive model for quantization parameters of at least two layers of the neural network is generated using the method.

These and other aspects of the invention will be apparent from and the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a schematic diagram of an evaluation of a neural network, according to an example.

FIG. 2 shows a block diagram of a method for generating a predictive model, according to an example.

FIG. 3 is a graph showing outputs of a predictive model, according to an example.

FIG. 4 shows a system comprising a memory and program code.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Quantization may be used to reduce the memory footprint and inference time in neural networks. Quantization methods compress data in a neural network from large floating point representations to smaller fixed-point representations. For example, a mapping of 32-bit floating point numbers to 8-bit integers may be applied to the weights and activations of a neural network. This 8-bit quantization can be applied to a pre-trained neural network model without degrading the accuracy of the output. Lower bit-width quantization permits greater optimization, however lowering the bit width to too great an extent requires additional fine-tuning of the quantization model to ensure that the accuracy of the output is maintained.

Quantization methods can be classified into two groups. Dynamic quantization methods compute quantization parameters on-the-fly. These methods compute statistics such as minima, maxima and standard deviation on the input data at each level of the neural network to generate quantization parameters for converting data to a lower bit-width. Dynamic techniques are stable to changes in data distributions between samples of data. However, there is a significant computational overhead. Moreover, neural network frameworks and devices may not support dynamic quantization.

Static quantization methods generate quantization parameters from a subset of a training dataset of the neural network. At the inference stage, the neural network uses the predefined quantization parameters. Static quantization is computationally efficient as there is no overhead during the inference stage. Moreover a convolution operation in a layer of the network may be fused with a subsequent quantization operation, providing further optimization. On the other hand, statically generated quantization parameters can produce inaccuracies in outputs due to changes in data distributions between samples.

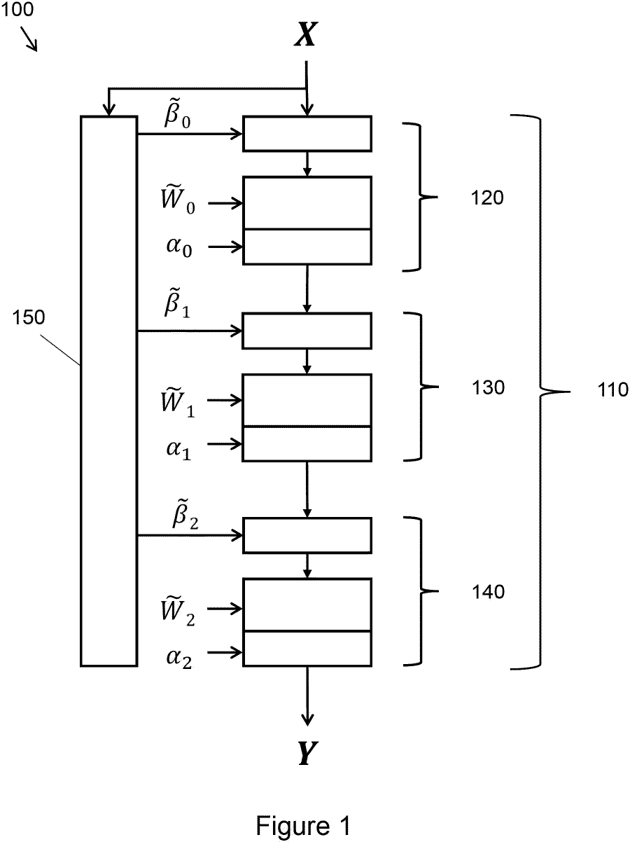

FIG. 1 is a schematic diagram 100 showing an evaluation of the stages of a quantized neural network 110, according to an example. The neural network 110 comprises an input layer and three further layers 120, 130, 140. At each of the layers of the network 110, the (non-quantized) output is represented as a matrix multiplication:

$${W}_{l} {X}_{l}$$

In equation (1) Wₗ is the matrix of weights of l-th layer of the network 110 and Xₗ is the output from the previous layer. According to examples described herein, Wₗ and Xₗ are, initially both matrices of, for example, 32-bit floating point numbers. A quantization mapping of the l-th layer is generated using the following expression:

$$\begin{matrix}{W}_{l} {X}_{l} = \left(\frac{{W}_{l}}{{α}_{l}}\right) \left(\frac{{X}_{l}}{{β}_{l}}\right) {α}_{l} {β}_{l} \approx R o u n d \left(\frac{{W}_{l}}{{α}_{l}}\right) R o u n d \left(\frac{{X}_{l}}{{β}_{l}}\right) {α}_{l} {β}_{l} = \\ {\tilde{W}}_{l} {\tilde{X}}_{l} {α}_{l} {β}_{l} .\end{matrix}$$

In Equation (2), the parameters αₗ and βₗ are referred to as quantization steps or scaling factors. The function Round takes as input a floating point number and rounds the number to the nearest whole integer. If 8-bit quantization is desired, the scaling factors αₗ and βₗ, are chosen such that performing a rounding operation on and generates

$$\frac{{W}_{l}}{{α}_{l}}$$

$$\frac{{X}_{l}}{{β}_{l}}$$

matrices and whose entries comprise 8-bit integers. For example, setting

$${α}_{l} = \frac{max \left|{W}_{l}\right|}{127}$$

and

$${β}_{l} = \frac{max \left|{X}_{l}\right|}{127}$$

where max(|▪|) is the maximum entry of the matrix, scales the entries of Wₗ and Xₗ from [—max|Wₗ, max|Wₗ|] and [—max|Xₗ| ,max|Xₗ|] to [-127,127].

Quantization of the weights Wₗ may be performed off-line, prior to the inference stage, since all the necessary data to compute the scaling factors αₗ is already available. In contrast, the scaling factor βₗ depends on the model input Xₗ at each layer. As previously described, two methods may be deployed to estimate the parameter βₗ: dynamic and static quantization. If dynamic quantization is used, an estimate of βₗ is generated using statistics determined from the input values Xₗ. If static quantization is used, βₗ is estimated using training data from a training dataset of the neural network.

In the methods and systems described herein, a predictor 150 is used to estimate the values of βₗ. The predictor 150 may be implemented in software or hardware (or a mix of both). The predictor 150 implements a predictive model that outputs an estimation of the quantization steps βₗ for each quantized layer, according to an input for the model.

In the example 100 shown in FIG. 1, the input, X to the predictive model is the input to the layer 120 of the neural network 110. The predictor 150 is arranged to output estimations

$${\tilde{β}}_{0} , {\tilde{β}}_{1} , {\tilde{β}}_{2}$$

on the basis of the input, X. In contrast to pure static quantization methods, the predictor 150 adjusts quantization parameters for layers of the neural network for each input sample, individually, at the inference stage.

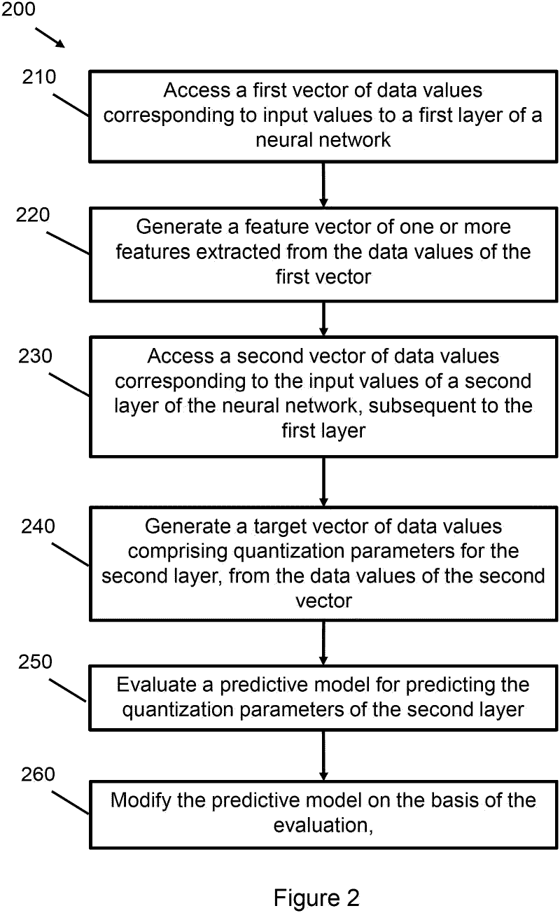

FIG. 2 is a block diagram showing a method 200 for generating a predictive model for quantization parameters of a neural network according to an example. The method 200 is implemented in conjunction with other methods and systems described herein.

At block 210, a first vector of data values corresponding to input values to a first layer of a neural network is accessed. According to examples, the first layer may correspond to the input layer. In other examples, the first layer may be a hidden layer. The first vector is generated on the basis of the evaluation of the neural network that is given by a sample from a training dataset for the neural network. For example, the first vector may correspond to the input X at the input layer of the neural network 110 i.e. an actual sample from the training dataset. In other cases, the first vector may correspond to the output from a hidden layer of the neural network.

At block 220 a feature vector of one or more features extracted from the data values of the first vector is generated:

$$\vec{f} = f \left(X\right) .$$

According to examples described herein, one or more of the features extracted from the data values of the first vector may comprises a statistical function computed from the data values of the first vector. For example, the feature vector may comprise the mean, variance, maximum and/or minimum value of the first vector X.

At block 230 a second vector of data values corresponding to the input values of a second layer, subsequent to the first layer of the neural network is accessed. For example, the second layer may correspond to the layer 120, 130 or 140. The second vector comprises a vector of data values that is generated on the basis of the evaluation of the same sample from the training dataset as the first vector.

At block 240, a target vector of data values comprising one or more quantization parameters for the second layer is generated from the data values of the second vector. That is to say, at the second layer, subsequent to the first layer, a target vector of quantization parameters is generated:

$$\vec{S} = \left({\vec{s}}^{1} , {\vec{s}}^{2} , ... , {\vec{s}}^{l} , ... , {\vec{s}}^{L}\right)$$

At block 250 a predictive model for predicting the one or more quantization parameters of the second layer is evaluated on the basis of the target vector. According to examples, the predictive model is a linear predictive function, a non-linear predictive function, a neural network, a gradient boosting machine, a random forest, a support vector machine, a nearest neighbour model, a Gaussian process, a Bayesian regression and/or an ensemble of the aforementioned processes.

In some examples, evaluating the predictive model comprises computing an output of the predictive model on the basis of the feature vector, and determining an error between the output and the target vector. That is the predictive model P is evaluated on the feature vector

$$\vec{f}$$

$$\vec{S} .$$

and a determination of an error is made between the output of P with the target vector S.

At block 260, the predictive model is modified on the basis of the evaluation. According to examples described herein, modifying the predictive model on the basis of the evaluation, comprises modifying one or more parameters of the predictive model to minimize the error between the output and the target vector.

The method 200 may be repeated for multiple layers of the neural network to obtain quantization parameters for each layer. For example, the method 200 may be implemented to generate a model that outputs quantization parameters for layers 120, 130, 140 shown in FIG. 1.

Quantization parameters for one or more subsets of the layers of the neural network may be generated using inputs from different layers. For example, quantization parameters for a first subset may be generated using a first model, generated using the input to a first layer and quantization parameters for a second subset may be generated using a second model generated using the input to a second layer. For example, in FIG. 1, instead of implementing a single predictor 150, two predictors may be used. For example, in one case a first predictor may comprise a first model that outputs parameters for layers 120 and 130 on the basis of the input X, and a second predictor may comprise a predictive model which takes input from the layer 130 and outputs parameters for the layer 140.

According to examples described herein, a predictive model generated using the method 200 may be deployed during the inference stage to estimate quantization parameters. In examples, a vector of data values corresponding to input values for a first layer of the neural network is received. A feature vector of one or more features extracted from the data values of the vector is generated. A predictive model generated according to the method 200 is evaluated on the basis of the feature vector and one or more quantization parameters for a second layer subsequent to the first layer are generated on the basis of the evaluation. That is, the values βₗ are estimated using the predictive model and applied during the inference stage.

In examples described herein a user may select which layers of the neural network to apply the methods described herein. In particular, a user may be able to select through, for example, a graphical user interface, a layer from which the first vector of data values is taken in the method 200, and one or more further layers to apply the method 200 to generate a predictive model for quantization parameters of the further layers.

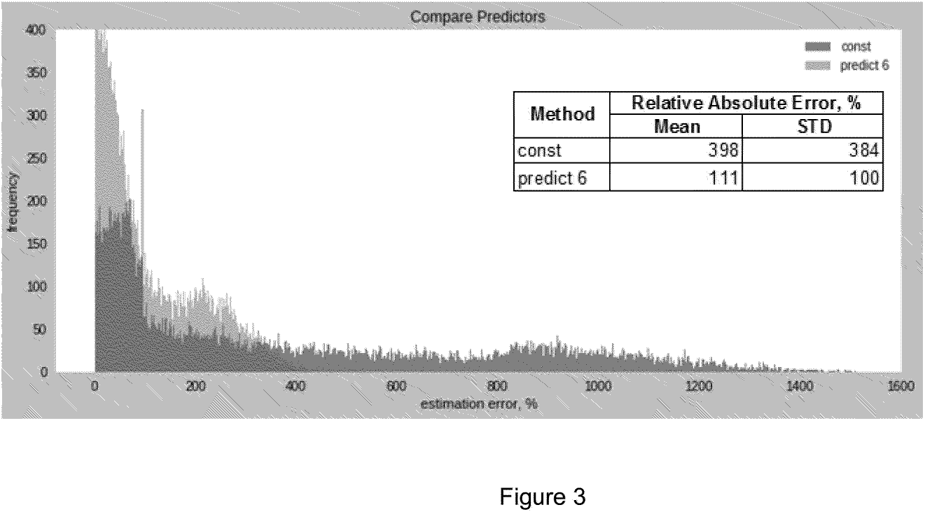

FIG. 3 shows a graph of quantization parameter prediction errors, according to an example. In FIG. 3 quantization parameters βₗ are estimated using a linear regression model. That is:

$${\tilde{β}}_{l} = \frac{{\tilde{max}}^{l}}{127}$$

where

$${\tilde{max}}^{l} = {\vec{p}}_{l} \vec{f} \left(\vert X \vert\right) + {P}_{L} ,$$

The following six features are computed from the model input X: ISO, mean, standard deviation, median, 90% percentile, 99% percentile. Using the method 200 to generate the linear regression model, reduces the mean and standard deviation of the error by a factor of four over choosing a constant value for the quantization steps.

The method described herein may be used adjust quantization parameters according to the input data. This adjustment increases model stability. The quantization error is decreased so that the accuracy of the neural network output is increased and variance is decreased. This reduces the amount of fine-tuning required after quantization.

The methods described herein have the advantages of static quantization methods with stability comparable to dynamic quantization methods. In particular the methods described herein are computationally efficient and the quantized convolutional layer can still be fused with the subsequent quantization layer. This is particularly efficient since the quantized layer receives quantized inputs and directly produces a quantized output. Furthermore, a scheme with a single quantization parameter predictor according to the method described herein does not require any modification to an existing neural network interface.

The quantization parameter predictor described herein may be used to predict any statistics, and not only simple statistics. This allows computationally complex parameter estimation methods to be applied to activations that may be too computationally complex to be applied in a dynamic setting.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, logic unit, or programmable gate set etc. The methods and modules may all be performed by a single processor or divided amongst several processors. Such machine-readable instructions may also be stored in a computer readable storage that can guide the computer or other programmable data processing devices to operate in a specific mode.

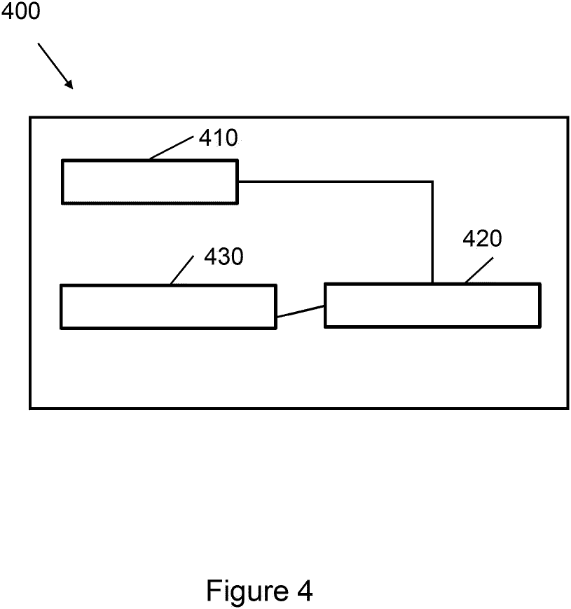

For example, the instructions may be provided on a non-transitory computer readable storage medium encoded with instructions, executable by a processor. FIG. 4 shows an example of a processor 410 associated with a memory 420. The memory 420 includes program code 430 which is executable by the processor 410. The program code 430 provides instructions to: access a first vector of data values corresponding to input values to a first layer implemented in a neural network, generate a feature vector of one or more features extracted from the data values of the first vector, access a second vector of data values corresponding to the input values of a second layer implemented in a neural network, subsequent to the first layer, generate a target vector of data values comprising one or more quantization parameters for the second layer, from the data values of the second vector, evaluate, on the basis of the feature vector and the target vector, a predictive model for predicting the one or more quantization parameters of the second layer; and modify the predictive model on the basis of the evaluation. The first and second vectors are generated on the basis of the evaluation of the neural network that is given by a sample from a training dataset for the neural network.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

It should be appreciated that one or more steps of the embodiment methods provided herein may be performed by corresponding units or modules. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A method for generating a predictive model for quantization parameters of a neural network, the method comprising:
accessing a first vector of data values corresponding to input values to a first layer implemented in the neural network;
generating a feature vector of one or more features extracted from the data values of the first vector;
accessing a second vector of data values corresponding to the input values of a second layer implemented in the neural network, wherein the second layer is subsequent to the first layer;
generating, from the data values of the second vector, a target vector of data values comprising one or more quantization parameters for the second layer;
evaluating, on the basis of the feature vector and the target vector, the predictive model for predicting the one or more quantization parameters of the second layer; and
modifying the predictive model on the basis of the evaluation of the predictive model,
wherein the first and second vectors are generated based on an evaluation of the neural network that is given by a sample from a training dataset for the neural network.

2. The method of claim 1, comprising:
receiving a vector of data values corresponding to input values for the first layer of the neural network;
generating a feature vector of one or more features extracted from the data values of the vector;
evaluating the predictive model on the basis of the feature vector; and
generating one or more quantization parameters for the second layer, on the basis of the evaluation.

3. The method of claim 1, wherein the first layer and the second layer are selected from layers of the neural network on the basis of a user-generated input.

4. The method of claim 1, wherein at least one of the features extracted from the data values of the first vector comprises a statistical function computed from the data values of the first vector.

5. The method of claim 1, wherein the predictive model is at least one of a linear predictive function, a non-linear predictive function, a neural network, a gradient boosting machine, a random forest, a support vector machine, a nearest neighbour model, a Gaussian process, a Bayesian regression, or an ensemble.

6. The method of claim 1, wherein evaluating the predictive model comprises: computing an output of the predictive model on the basis of the feature vector, and determining an error between the output and the target vector.

7. The method of claim 6, wherein modifying the predictive model on the basis of the evaluation of the predictive model comprises modifying one or more parameters of the predictive model to minimize the error between the output and the target vector.

8. The method of claim 2, wherein the quantization parameters comprise parameters of a function that maps floating point numbers to fixed point numbers.

9. (canceled)

10. A system, comprising:
at least one processor; and
at least one memory including program code which when executed by the at least one processor provides instructions to:
access a first vector of data values corresponding to input values to a first layer implemented in a neural network;
generate a feature vector of one or more features extracted from the data values of the first vector;
access a second vector of data values corresponding to the input values of a second layer implemented in the neural network, wherein the second layer is subsequent to the first layer;
generate, from the data values of the second vector, a target vector of data values comprising one or more quantization parameters for the second;
evaluate, on the basis of the feature vector and the target vector, a predictive model for predicting the one or more quantization parameters of the second layer; and
modify the predictive model on the basis of the evaluation of the predictive model,
wherein the first and second vectors are generated based on an evaluation of the neural network that is given by a sample from a training dataset for the neural network.

11. The system of claim 10, wherein the program code further provides instructions to:
receive a vector of data values corresponding to input values for first layer of the neural network;
generate a feature vector of one or more features extracted from the data values of the vector;
evaluate the predictive model on the basis of the feature vector; and
generate one or more quantization parameters for the second layer, on the basis of the evaluation.

12. The system of claim 10, wherein the program code further provides instructions to select the first layer and second layer from layers of the neural network on the basis of a user-generated input received at the system.

13. The system of claim 10, wherein at least one of the features extracted from the data values of the first vector comprises a statistical function computed from the data values of the first vector.

14. The system of claim 10, wherein the predictive model is at least one of a linear predictive function, a non-linear predictive function, a neural network, a gradient boosting machine, a random forest, a support vector machine, a nearest neighbour model, a Gaussian process, a Bayesian regression, or an ensemble.

15. The system of claim 10, wherein, to evaluate the predictive model the program code further provides instructions to:
compute an output of the predictive model on the basis of the feature vector, and
determine an error between the output and the target vector.

16. The system of claim 15, wherein to the program code further provides instructions to modify one or more parameters of the predictive model to minimize the error between the output and the target vector.

17. The system of claim 10, wherein the quantization parameters comprise parameters of a function that maps floating point numbers to fixed point numbers.

18. (canceled)

19. A non-transitory computer-readable medium storing computer instructions, that when executed by one or more hardware processors, cause the one or more hardware processors to perform operations comprising:
accessing a first vector of data values corresponding to input values to a first layer implemented in a neural network;
generating a feature vector of one or more features extracted from the data values of the first vector;
accessing a second vector of data values corresponding to the input values of a second layer implemented in the neural network, wherein the second layer is subsequent to the first layer;
generating, from the data values of the second vector, a target vector of data values comprising one or more quantization parameters for the second layer;
evaluating, on the basis of the feature vector and the target vector, a predictive model for predicting the one or more quantization parameters of the second layer; and
modifying the predictive model on the basis of the evaluation of the predictive model,
wherein the first and second vectors are generated based on an evaluation of the neural network that is given by a sample from a training dataset for the neural network.

20. The non-transitory computer-readable medium of claim 19, wherein the operations comprise:
receiving a vector of data values corresponding to input values for the first layer of the neural network;
generating a feature vector of one or more features extracted from the data values of the vector;
evaluating the predictive model on the basis of the feature vector; and
generating one or more quantization parameters for the second layer, on the basis of the evaluation.

21. The non-transitory computer-readable medium of claim 19, wherein the first layer and the second layer are selected from layers of the neural network on the basis of a user-generated input.

22. The non-transitory computer-readable medium of claim 19, wherein at least one of the features extracted from the data values of the first vector comprises a statistical function computed from the data values of the first vector.
